(19) United States
(12) Patent Application Publication
(10) Pub. No.: US 2003/0099454 A1
(43) Pub. Date: May 29, 2003

(54) Variable attenuator

(76) Inventor: Sean Chang, Hsintien City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/193,806

(22) Filed: Jul. 12, 2002

(30) Foreign Application Priority Data
Nov. 23, 2001 (TW) 90129108

(51) Int. Cl. G02B 6/00

(52) U.S. Cl. 385/140

(57) ABSTRACT

A variable attenuator. The variable attenuator includes an input end, an output end, a plate glass or a prism and a rotating mechanism. The input end outputs a collimated light beam. The output end is placed on the transmitting route of the collimated light beam for receiving the collimated light beams outputted from the input end. The plate glass or the prism is disposed between the input end and the output end. The rotating mechanism is coupled to the plate glass or the prism for rotating the plate glass or the prism. Thus, the collimated light beam deviates from the original transmitting route. The attenuation of the collimated light beam received by the output end can be controlled by actuating the rotating mechanism to shift the collimated light beam.

### BACKGROUND OF THE INVENTION

1. Field of the Invention

The present invention relates to a variable attenuator, and in particular to a variable optical attenuator using a rotatable plate glass or triangular prism to attenuate output light beams.

2. Description of the Related Art

Referring to FIG. 1, the conventional variable attenuator 1 includes a light source 2, a block 3 and a receiving end 4. The light source 2 outputs collimated light beams to be incident on the block 3. The block 3 moves in a direction perpendicular to the transmitting direction of the collimated light beams. Thus, the attenuation of the collimated light beams is regulated by controlling the blocked area of the collimated light beams on the block 3.

There is a significant drawback for the conventional variable attenuator because the conventional variable attenuator 1 requires a large space to accommodate the block 3, thus occupying a large total volume.

### SUMMARY OF THE INVENTION

An object of the invention is to provide a variable optical attenuator. The attenuator includes a collimator outputting collimated light beams; a receiving end placed on the transmitting route of the collimated light beams; a plate glass or a prism disposed between the collimator and the receiving end; and a driving mechanism coupled to the plate glass for rotating the plate glass or the prism to a predetermined inclined angle.

Thus, the collimated light beams deviate from the original transmitting route. The attenuation of the collimated light beams received by the receiving end can be controlled by actuating the driving mechanism to shift the collimated light beams.

A detailed description will be given by the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a conventional variable attenuator;

FIG. 2 is a schematic view showing the first embodiment of the variable attenuator of the present invention, wherein the collimated light beam is incident on a plate glass perpendicularly;

FIG. 3 is a schematic view showing the first embodiment of the variable attenuator of the present invention, wherein the collimated light beam is incident on a plate glass at a predetermined incident angle;

FIG. 4 is a schematic view showing the second embodiment of the variable attenuator of the present invention, wherein the collimated light beam is incident on a triangular prism perpendicularly;

FIG. 5 is a schematic view showing the second embodiment of the variable attenuator of the present invention, wherein the collimated light beam is incident on a triangular prism at a predetermined incident angle;

FIG. 6 is a schematic view showing the third embodiment of the variable attenuator of the present invention, wherein the collimated light beam is incident on a triangular prism at a predetermined incident angle;

FIG. 7 is a schematic view showing the third embodiment of the variable attenuator of the present invention, wherein the collimated light beam is incident on a triangular prism at another predetermined incident angle;

FIG. 8A is a schematic view showing the shifted collimated light beam received by the receiving end, wherein the shift (d) of the shifted collimated light beam is less than the radius (D/2) of the collimated light beam; and

FIG. 8B is a schematic view showing the shifted collimated light beam received by the receiving end, wherein the shift (d) of the shifted collimated light beam is greater than the radius (D/2) of the collimated light beam.

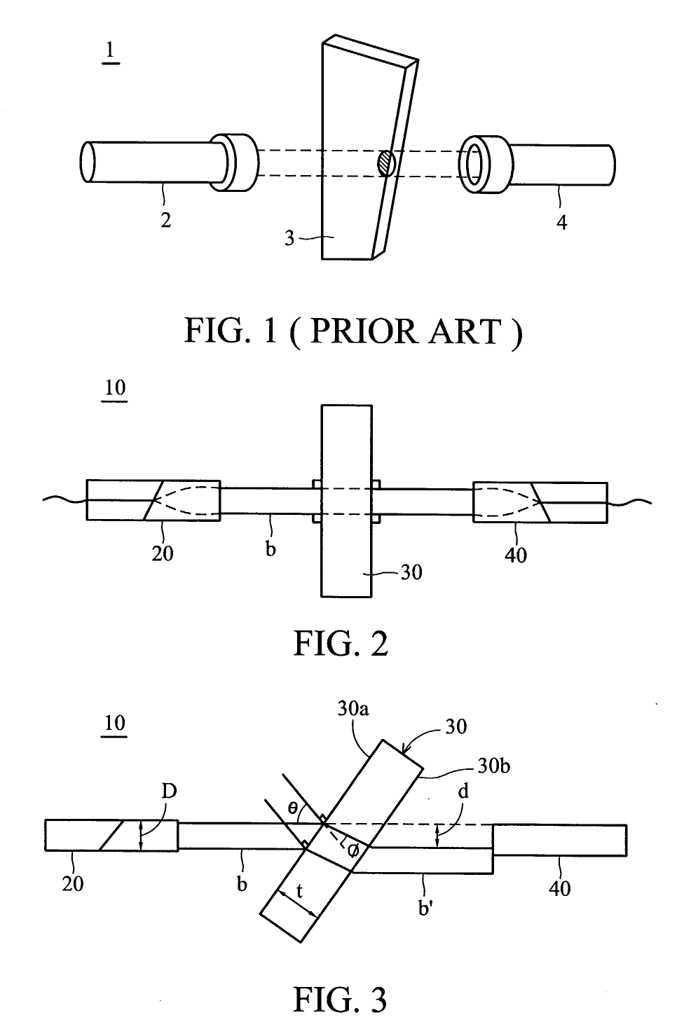

### DETAILED DESCRIPTION OF THE INVENTION

First Embodiment

Referring to FIG. 2, the collimated light beam is incident on a plate glass perpendicularly. The variable optical attenuator 10 includes a collimator 20, a receiving end 40 and a plate glass 30. The receiving end 40 can be provided with another collimator. When the collimator 20 outputs the collimated light beams b, the collimated light beam b is incident on the plate glass 30 perpendicularly. Then, the collimated light beams b penetrating the plate glass 30 are completely received by the receiving end 40. Thus, the collimated light beams b are hardly attenuated.

Referring to FIG. 3, the collimated light beam is incident on a plate glass at a predetermined incident angle. The plate glass 30 can be rotated by a driving mechanism (not shown). The collimated light beam b output from the collimator 20 is incident on the plate glass 30 at an incident angle θ by rotating the plate glass 30. When the collimated light beam b penetrates the plate glass 30, the collimated light beam b deviates from the original transmitting route according to the refraction law. The shifted collimated light beam b′ is parallel to the collimated light beam b and received by the receiving end 40. As shown in FIG. 3, the shifted collimated light beams b′ have a shift d. Thus, a part of the shifted collimated light beams b′ are not received by the receiving end 40.

In the first embodiment, the cross-sectional area of the collimated light beam b outputted by the collimator 20 is expressed as follows:

$$A1 = \frac{π {D}^{2}}{4} , \qquad ( 1 )$$

wherein D is the diameter of the collimator 20.

As mentioned above, the collimated light beam b is incident on the plate glass 30 at an incident angle θ via the surface 30a. According to the Snell's law, the light beam is refracted in the plate glass 30 at a refracting angle φ. Then, the light beam leaves the plate glass 30 at the refracting angle θ via the surface 30b. The shift d of the shifted collimated light beam b′ is expressed as follows:

$$d = \frac{t}{cos φ} \times sin ( θ - φ ) , \qquad ( 2 )$$

wherein t is the thickness of the plate glass 30; sinθ=nsinφ, n is the refractive index of the plate glass 30.

Second Embodiment

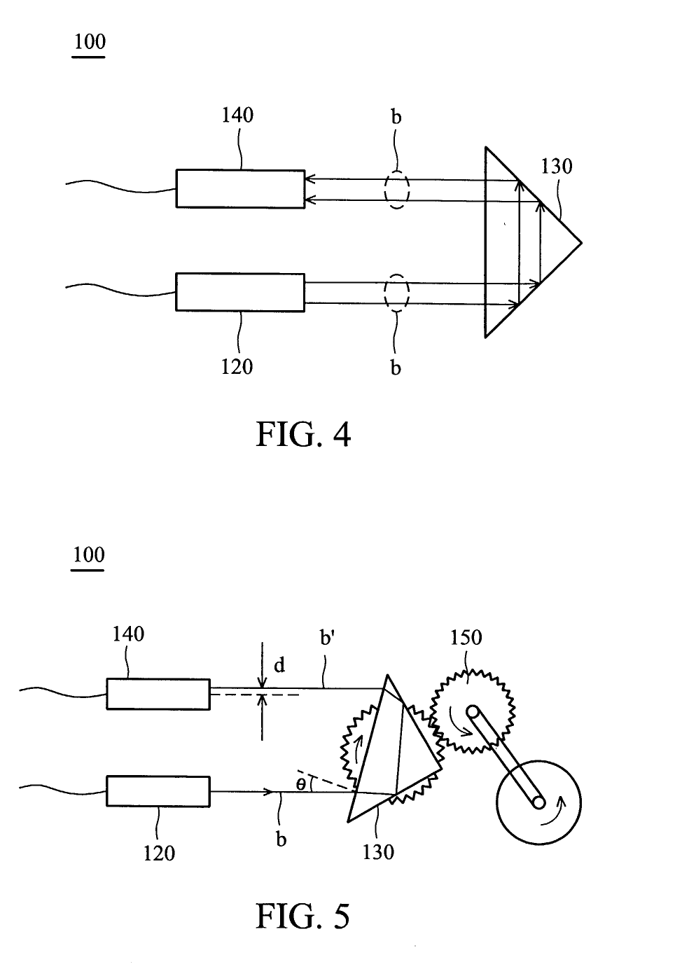

Referring to FIG. 4, the collimated light beam is incident on a triangular prism perpendicularly. The variable optical attenuator 100 includes a collimator 120, a receiving end 140 and a triangular prism 130. When the collimator 120 outputs the collimated light beam b, the collimated light beam b is incident on the triangular prism 130 and leaves the triangular prism 130 by way of two total reflections. Then, the collimated light beams b are received by the receiving end 140 which is provided with another collimator. The collimated light beam b is completely received by the receiving end 140 by way of the two total reflections in the triangular prism 130. Thus, the collimated light beam b is hardly attenuated.

Referring to FIG. 5, the collimated light beam is incident on a triangular prism at a predetermined incident angle. The triangular prism 130 can be rotated by a rotating mechanism 150. The collimated light beam b from the collimator 120 is incident on the triangular prism 130 at an incident angle θ by rotating the triangular prism 130. When the collimated light beam b penetrates the triangular prism 130, the collimated light beam b deviates from the original transmitting routes according to the refraction and the reflection laws. The shifted collimated light beam b′ is parallel to the collimated light beam b and received by the receiving end 140. As shown in FIG. 5, the shifted collimated light beam b′ has a shift d. Thus, a part of the shifted collimated light beam b′ is not received by the receiving end 140.

Third Embodiment

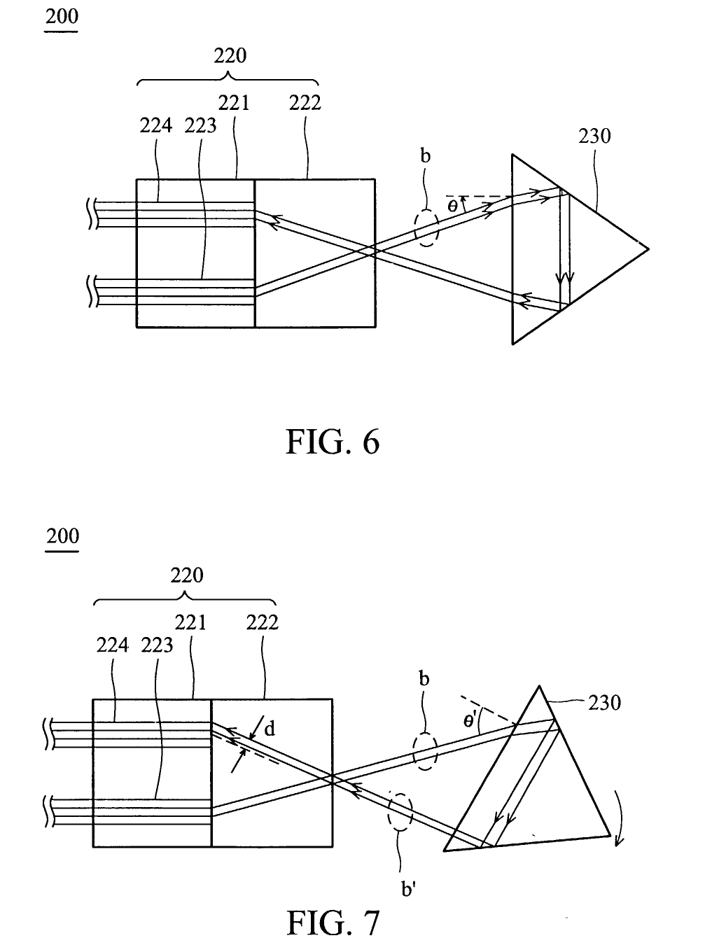

Referring to FIG. 6, the collimated light beam is incident on a triangular prism at a predetermined incident angle. The variable optical attenuator 200 includes a dual-fiber collimator 220 and a triangular prism 230. The dual-fiber collimator 220 includes a glass ferrule 221, a GRIN lens 222, an input fiber 223 and an output fiber 224. When the input fiber 223 transmits the collimated light beam b, the collimated light beam b is incident on the triangular prism 230 at an incident angle θ and leaves the triangular prism 230 by way of two total reflections. Then, the collimated light beam b is received by the output fiber 224. The collimated light beam b is completely received by the output fiber 224 by way of the two total reflections in the triangular prism 230. Thus, the collimated light beam b is hardly attenuated.

Referring to FIG. 7, the collimated light beam is incident on a triangular prism at another predetermined incident angle. The triangular prism 230 can be rotated by a rotating mechanism (not shown). The collimated light beam b from the input fiber 223 is incident on the triangular prism 230 at an incident angle θ′ by rotating the triangular prism 230. The collimated beam b penetrates the triangular prism 230 by way of two total reflections. Then, the shifted collimated light beam b′ is received by the output fiber 224. As shown in FIG. 7, the shifted collimated light beam b′ has a shift d. Thus, a part of the shifted collimated light beam b′ is not received by the output fiber 224.

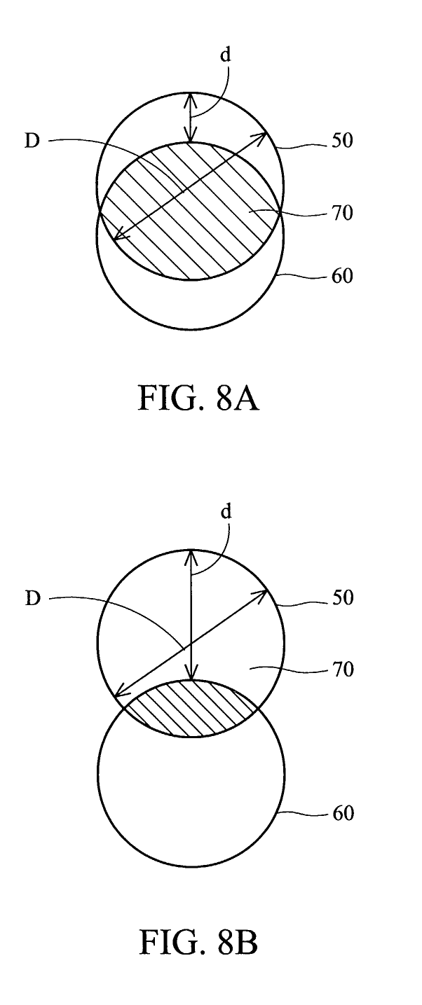

Referring to FIG. 8A, the shift (d) of the shifted collimated light beam is less than the radius (D/2) of the collimated light beam. The first circle 50 is the cross section of the receiving end and the second circle 60 is the cross section of the shifted collimated light beam b′. The shaded portion 70 is the area that the shifted collimated light beam b′ incident on the receiving end. When the first circle 50 and the cross section of the collimated light beam b have the same diameter D, the area A2 of the shaded portion 70 is expressed as follows:

$$A2 = 4 {( \frac{D}{2} )}^{2} {cos}^{- 1} ( 1 - \frac{X}{D} ) - ( D - X ) \sqrt{\frac{DX}{2} - \frac{{X}^{2}}{4}} , wherein \\ X = D - d = D - \frac{t}{cos φ} \times sin ( θ - φ ) . \qquad ( 3 )$$

In addition, the light intensity Iᵣ on the receiving end is expressed as follows:

$${I}_{r} = {I}_{0} \times \frac{A2}{A1} , \qquad ( 4 )$$

wherein I₀ is the light intensity of the collimated light beam b from the collimator.

Referring to FIG. 8B, the shift (d) of the shifted collimated light beam is greater than the radius (D/2) of the collimated light beam. When the first circle 50 and the cross section of the collimated light beam b have the same diameter D, the area A2′ of the shaded portion 70 is expressed as follows:

$${A2}^{′} = 4 {( \frac{D}{2} )}^{2} {cos}^{- 1} ( \frac{Y}{D} ) - Y \sqrt{{( \frac{D}{2} )}^{2} - ( \frac{{Y}^{2}}{4} )} , wherein \\ Y = d = \frac{t}{cos φ} \times sin ( θ - φ ) . \qquad ( 5 )$$

In addition, the light intensity Iᵣ′ on the receiving end is expressed as follows:

$${I}_{r}^{′} = {I}_{0} \times \frac{{A2}^{′}}{A1} , \qquad ( 6 )$$

wherein I₀ is the light intensity of the collimated light beams b from the collimator.

Consequently, in the embodiments of the present invention, the light intensity of the output light beam received by the receiving end can be attenuated by rotating the plate glass or triangular prism according to equations (4) and (6).

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A variable attenuator, comprising:
an input end outputting a collimated light beam;
a receiving end placed on the transmitting route of the collimated light beams; and
a plate glass disposed between the input end and the receiving end;
whereby, the collimated light beam deviates from the original transmitting route and is received by the receiving end after the collimated light beams penetrate the plate glass.

2. The variable attenuator as claimed in claim 1, wherein the receiving end and the input end are provided with a collimator, respectively.

3. The variable attenuator as claimed in claim 1, further comprising a rotating mechanism coupled to the plate glass for rotating the plate glass to a predetermined inclined angle so as to attenuate the intensity of the collimated light beam received by the receiving end.

4. A variable attenuator, comprising:
an input end outputting a collimated light beam;
a prism receiving the collimated light beam, the collimated light beams penetrating the prism by total reflections inside the prism; and
an output end receiving the collimated light beam;
when an inclined angle of the prism is changed, the collimated light beam penetrating the prism is shifted and received by the output end.

5. The variable attenuator as claimed in claim 4, further comprising a rotating mechanism coupled to the prism for rotating the prism and changing the light intensity of the collimated light beam received by the output end.

6. The variable attenuator as claimed in claim 4, wherein the prism is a triangular prism.

7. The variable attenuator as claimed in claim 4, wherein the input and output ends are provided with a collimator, respectively.

8. A variable attenuator, comprising:
a collimator having an output fiber and an input fiber, wherein the input fiber outputs a collimated light beam and the output fiber receives the collimated light beam; and
a prism receiving the collimated light beam, the collimated light beams penetrating the prism by total reflections inside the prism;
when an inclined angle of the prism is changed, the collimated light beam penetrating the prism is shifted and received by the output fiber.

9. The variable attenuator as claimed in claim 8, further comprising a rotating mechanism coupled to the prism for rotating the prism and changing the light intensity of the collimated light beam received by the output fiber.
